(19) United States
(12) Patent Application Publication
(10) Pub. No.: US 2018/0183931 A1
(43) Pub. Date: Jun. 28, 2018

(54) Unanswered-Call Handling and Routing

(71) Applicant: Mutare Inc., Rolling Meadows, IL (US)

(72) Inventors: Richard Quattrocchi, Barrington, IL (US); Edward O'Brien, Arlington Heights, IL (US); Bennett Crown, Arlington Heights, IL (US); Brian McDonald, Bartlett, IL (US); Michael Sorensen, Wheaton, IL (US); Roger Northrop, Mount Prospect, IL (US)

(21) Appl. No.: 15/852,871

(22) Filed: Dec. 22, 2017

Related U.S. Application Data
(60) Provisional application No. 62/438,789, filed on Dec. 23, 2016.

(51) Int. Cl. H04M 3/533; G10L 15/26; G06F 17/21; G06F 17/27

(52) U.S. Cl. CPC H04M 3/53308; G10L 15/265; G06F 17/211; H04M 3/42059; H04M 2201/60; H04M 2203/4536; G06F 17/2785

(57) ABSTRACT

An apparatus provides calling parties with an opportunity to record a voice message when their incoming call goes unanswered and to then automatically transcribe that voice message to text which the apparatus then forwards to the called party without also maintaining the recorded voice message in a voice-mail system.

### RELATED APPLICATION(S)

This application claims the benefit of U.S. Provisional application number 62/438,789, filed Dec. 23, 2016, which is incorporated by reference in its entirety herein.

### TECHNICAL FIELD

These teachings relate generally to call-handling apparatuses and more particularly to apparatuses configured to process unanswered calls.

### BACKGROUND

Voice-mail systems are known in the art. Voice-mail systems are computer-based systems that record, store, and play back voice messages provided by callers when their calls to a particular called party are unanswered. More particularly, when a telephone call goes unanswered, the system (usually in conjunction with voice prompts) provides the caller with an opportunity to record a voice message for the called party. The system then typically provides one or more alerts (such as a blinking light on the called-party's telephone station or a quickly-beeping tone that plays momentarily when that telephone station is taken off-hook) to alert the user as to the availability of that message.

Many voicemail systems function as a remote answering machine using touch-tones as the user interface. By pressing appropriate keys on their telephone station, the user can access, playback, pause, forward, and/or delete their recorded voice messages.

Many modern users find the traditional voice-mail paradigm to be unsatisfactory. In particular, the user interface itself can be cumbersome and ill-suited to the time-management strategies and tactics of modern users. For example, the substantive content of a voice message may comprise only a small part of the overall temporal length of the message. The latter circumstance results from, for example, voiced pleasantries, repetition, silent pauses as the caller collects and organizes their thoughts, and so forth. As a result, many users do not keep as current with their voicemail systems as they should and many actually completely eschew use of their systems.

As a result, voice messages can go unheard and unanswered for considerable lengths of time or may even be systematically ignored. At best, even responsible use of a voice-mail system can test the patience of the user in various ways that lead to user dissatisfaction.

Also, traditional voice mail systems typically require at least one of an access number, a password or other code, and/or other supplemental information to facilitate accessing the system. Any system that requires such additional content inherently delays the user's access to the desired content and, in addition, often leads to failed efforts to access the content when the user incorrectly enters the information or forgets their information.

### BRIEF DESCRIPTION OF THE DRAWINGS

The above needs are at least partially met through provision of the unanswered-call handling and routing apparatus described in the following detailed description, particularly when studied in conjunction with the drawings, wherein:

FIG. 1 comprises a block diagram as configured in accordance with various embodiments of these teachings; and

FIG. 2 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a suitably configured apparatus provides calling parties with an opportunity to record a voice message when their incoming call goes unanswered and to then automatically transcribe that voice message to text which the apparatus then forwards to the called party without also maintaining the recorded voice message in a voice-mail system and without otherwise offering voice-mail playback services. (As used herein, the expression “voice-mail playback services” will be understood to refer to voice-based telephony-styled communication services that (1) record a calling party's message when the call cannot be otherwise completed and (2) provide an alert to the called party via their telephone interface to inform the called party of the availability of that recorded message following which the called party (3) can select to playback the recorded message as many times as they wish, store the recorded message, and delete the recorded message.)

By one approach these teachings provide a control circuit that operably couples to a private branch exchange (PBX) and at least one network. The control circuit can be configured to receive a forwarded call for a target recipient from the PBX and then receive, via that forwarded call, a speech message that the control circuit records to provide a recorded speech message. The control circuit then provides for automatically converting at least a part of the recorded speech message into a corresponding transcribed text message. The control circuit then automatically deletes at least a majority of the recorded speech message without first making the recorded speech message available to the target recipient via a voice-mail system.

In a typical application setting the aforementioned forwarded call will comprise an unanswered forwarded call. Also in a typical application setting the control circuit can be further configured to automatically forward at least a part of the transcribed text message to the target recipient and/or to a recipient other than the originally-called target recipient.

These teachings are highly flexible in practice and will accommodate various modifications and supplemental functionality. By one approach, for example, the control circuit can accomplish the aforementioned conversion of the recorded speech message into a corresponding transcribed text message by forwarding at least a part of the recorded speech message to an external speech transcription resource.

As another example in these regards, the control circuit can be further configured to determine when a transcribed text message includes one or more predetermined expressions of interest. Upon detecting the inclusion of such an expression the control circuit can then automatically take one or more corresponding response of actions. Examples in these regards include, but are not limited to, highlighting predetermined expressions of interest in the transcribed text message when forwarding the latter to a recipient, selecting a particular recipient to receive the transcribed text message as a function of the detected expression of interest, and/or archiving at least a portion of the transcribed text message.

And as another example in these regards, the control circuit can be further configured to access additional information and include the additional information when forwarding the transcribed text message to the recipient. That additional information may be accessed as a function, at least in part, of the content of the transcribed text message, an identity of a party that originated the call, and so forth. The additional information itself may comprise, for example, contact information regarding a party that originated the call, personal information regarding the party that originated the call, and/or professional information regarding the party that originated the call.

And as yet another example in these regards, the control circuit can be further configured to automatically analyze the recorded speech message to provide corresponding analytical content such as, but not limited to, a conclusion regarding a gender of the person who voiced the speech message, a conclusion regarding an emotional state of the person who voiced the speech message, a conclusion regarding a number of speakers (i.e., how many speakers) voiced the speech message, a measure of a temporal duration of the speech message, and so forth. By one approach that analytical content can comprise, in whole or in part, automatically identified trending expressions.

The resultant text-based conveyance of voice messages can provide a considerably better user experience for many persons. As a result, phone messages are less likely to go “unheard” and unanswered.

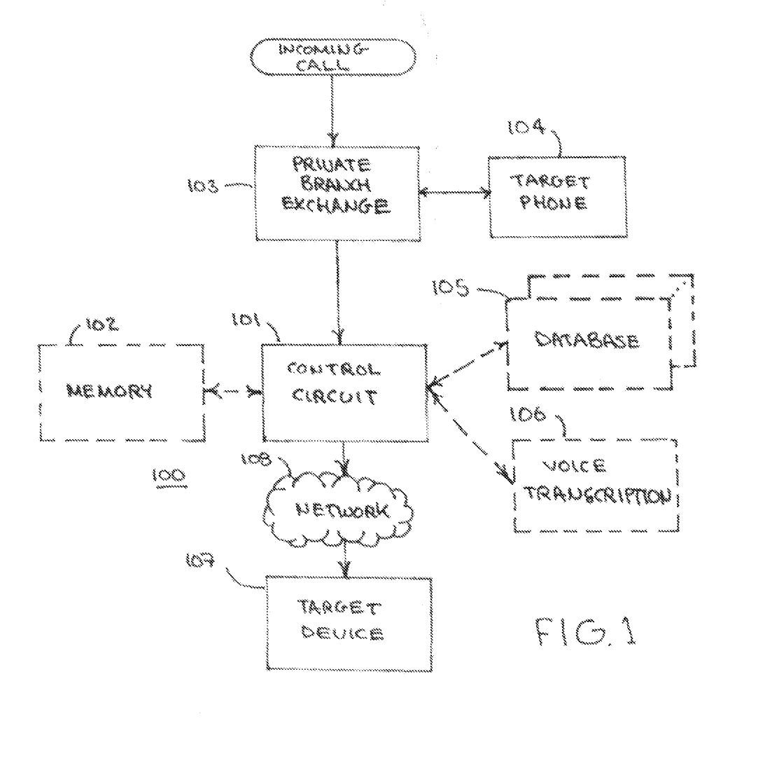

These and other benefits may become clearer upon making a thorough review and study of the following detailed description. Referring now to FIG. 1, an illustrative apparatus 100 that is compatible with many of these teachings will now be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to temporarily storing voice files, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this illustrative example the aforementioned control circuit 101 operably couples to a private branch exchange (PBX) 103. It should be understood that the PBX 103 and the control circuit 101 may be physically located a considerable distance from one another (for example, by at least 1 mile, by at least 5 miles, by at least 100 miles, or some other significant distance) and may also be owned and/or operated by or on behalf of differing enterprises. In one illustrative application setting, for example, the enterprise that operates the PBX 103 may contract with the enterprise that operates the control circuit 101 to receive some or all of the services described herein. (Private Branch Exchanges are very well known in the art. Accordingly, for the sake of brevity, further details regarding the structure and functionality of a PBX are not provided here save where specifically appropriate to this detailed description.)

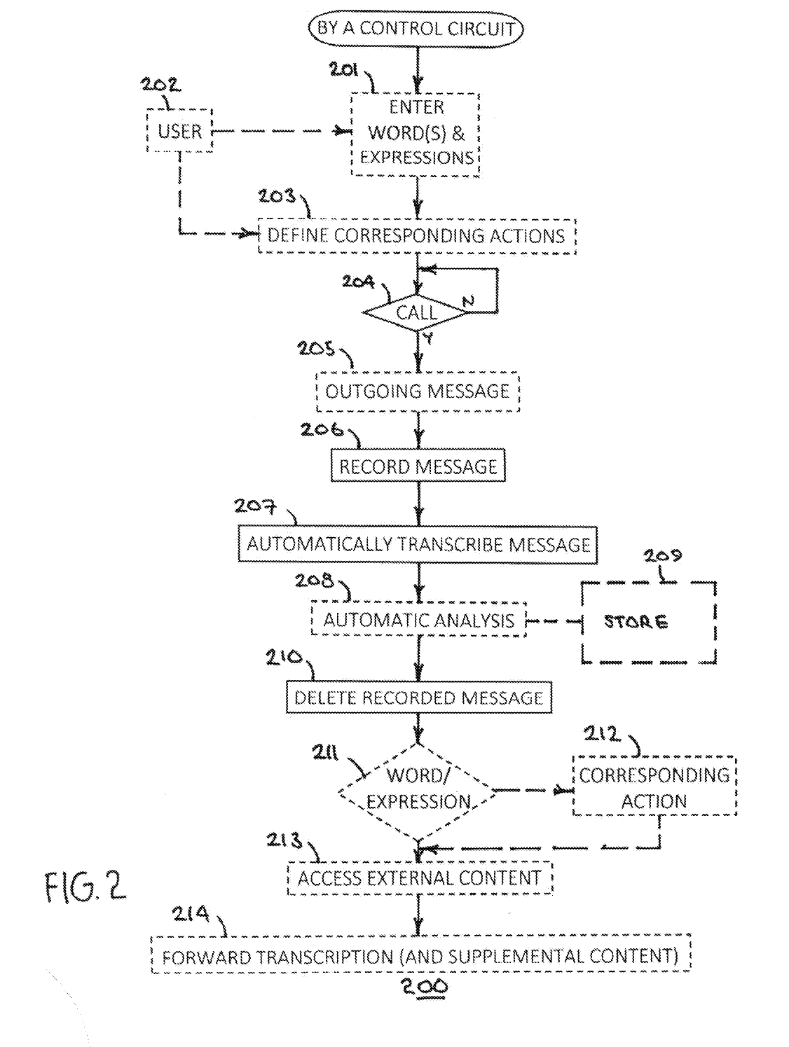

Referring now to both FIGS. 1 and 2, the control circuit 101 can be configured to carry out the process 200 presented in FIG. 2.

As an initial optional activity, and with reference to block 201, the illustrated process 200 provides a user 202 (such as persons who use the services of the PBX 103, a system administrator, and so forth) with an opportunity to identify one or more expressions of interest. (As used herein, “expressions” shall be understood to refer to one or more words or word parts, including full or incomplete sentences if desired.) By one approach the aforementioned opportunity comprises presenting the user with already-available expressions from which the user can select. By another approach, in lieu of the foregoing or in combination therewith, this opportunity can comprise one or more text-entry fields in which the user can enter the expression(s) of interest.

If desired, the aforementioned apparatus 100 can include a user interface (not shown) that operably couples to the control circuit 101. This user interface can provide an expedient way for the user to enter or to otherwise select the aforementioned expressions of interest. This user interface can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

If desired, and in combination with the foregoing, at block 203 this process 200 provides an opportunity for the user (or another party if desired) to define corresponding actions for one or more of the aforementioned expressions of interest. For example, the word “bomb” could be identified as an expression of interest and one corresponding action could be to automatically forward a message containing that expression to one or more predetermined email addresses. Other examples of corresponding actions include, but are certainly not limited to, highlighting the expression in the text of a forwarded transcribed message, selecting a particular recipient to receive the transcribed text message that includes the expression, and archiving at least a portion of the transcribed text message that contains the expression of interest, to note but a few.

By one approach, the PBX 103 operates pursuant to its primary functionality to direct incoming calls to corresponding target phones 104 within the service area of the PBX 103. Pursuant to these teachings, however, when a particular incoming call for a particular target phone 104 goes unanswered (as determined, for example, when the ringing of the target phone 104 goes at least a certain number of rings without the target phone 104 being answered), the PBX 103 forwards the as yet unanswered call to the control circuit 101.

At block 204, upon detecting such a call, in a typical (but optional) application setting the control circuit 101 responds to that call at block 205 with an automated outgoing recorded (or synthesized) voice message of choice. At the least this message provides the caller with an opportunity to leave a voice message (i.e., a spoken-only message) for the called party. That opportunity may happen automatically or, for example, when the calling party presses a particular key or keys on their own telephone.

Presuming that the calling party opts to leave a message, at block 206 the control circuit 101 makes, or arranges to have made, a digital recording of that voice message using a suitable file format of choice. The prior art is replete with numerous approaches and methodologies in these regards. As the present teachings are not overly sensitive to any particular selection amongst these choices, for the sake of brevity no further elaboration is provided here regarding such recordings.

If desired, the control circuit 101 can also capture (for example, as metadata for the aforementioned digital recording) other available information such as the time of the call, the temporal duration of the digital recording, caller identification information for the caller, and so forth. That information can be temporarily stored, for example, in the aforementioned memory 102.

Pursuant to these teachings at block 207 the control circuit 101 then automatically transcribes that digital recording to a textual transcription. By one approach the control circuit 101 makes part or all of that conversion itself. By another approach the control circuit 101 makes use of a remote voice transcription resource 106 to transcribe part or all of the voice message. In any case the control circuit 101 thereby produces a text file/document that corresponds to the voice message.

It is of course possible that the automated speech-to-text conversion process includes errors in the form of mis-translated words or even non-translatable utterances. In many cases, however, such errors/exclusions are not fatal errors as the recipient will often be able to glean at least the gist of the substantive content notwithstanding such errors or omissions.

By one approach, and as illustrated at optional block 208, these teachings will accommodate automatically analyzing the recorded speech message to provide corresponding analytical content. Examples in these regards include but are not limited to detecting, characterizing, and assessing message sentiment and/or an emotional state of the person who voiced the speech message, the gender of the caller, the number of individual speakers who contributed to the speech message, a measure of the temporal duration of the speech message, and audio quality of the speech message.

As another example in these regards the content of the transcribed message can be automatically analyzed to identify and note trending expressions. That is, expressions such as particular nouns or short combinations of words that are “trending” because they are occurring with relatively high frequency over many messages from many different parties. For example, when the users of a particular PBX 103 are elected officials and their administrative assistants, it can be useful to understand when a considerable number of their received messages from their constituents all contain identical words like “taxes,” “health care,” and so forth. In cases like this the analysis can include related statistics such as what percentage of all incoming messages on a given day include which automatically-noted and tracked expressions.

The results of the foregoing automated analysis can then be stored 209 for later use as desired.

At this point, and by one approach, at block 210 the digital recording is now deleted. For example, the digital recording may be deleted automatically within, say, 1 second, 5 seconds, 1 minute, 10 minutes, or 1 hour of completing the aforementioned transcription. At the very least the digital recording is not placed into a traditional record/store/playback voice-mail system as these teachings presume dispensing with any such system. By one approach, if desired, the digital recording, or some part thereof, may be archived for some set period of time such that a system administrator might be able to access the recording but not the called party (at least in ordinary course of usage). Such archiving can serve, for example, to help with quality assurance regarding the corresponding automated transcriptions.

By one optional approach, at block 211 the control circuit 101 determines whether the transcribed message includes any expressions of interest (such as, for example expressions of interest that a user entered or identified per the description provided above for block 201). When true, the control circuit 101 can take the appropriate action at block 212 that corresponds to the detect expression(s).

At optional block 213 the control circuit 101 access external content comprising additional information of interest. “External” content will be understood to refer to content that is not explicitly included in the original spoken message and that is not otherwise a part of the original call (such as caller identification information). By one approach the external content is accessed as a function, at least in part, of at least one of the content of the transcribed text message and the identity of the party that originated the call. The external content can be drawn from any one or more of a variety of public and non-public resources as desired, including consumer relationship management databases, on-line biographies from professional social networking services, and so forth.

Examples of such additional information include, but are not limited to, contact information regarding a party that originated the call (such as email addresses, twitter handles, and so forth), personal information regarding the party that originated the call (such as their name, their families, and so forth), and professional information regarding the party that originated the call (such as their employer, their academic history and alma maters, and so forth).

At block 214 the control circuit 101 then arranges to forward that text version of the message to the called party by forwarding a message containing that text version to a target device 107 (such as a desktop or laptop computer or a so-called smartphone) for the called party via, for example, one or more intervening networks 108 (such as but not limited to the Internet and/or an available wireless data network). The text can be sent to the called party using a proprietary format/medium or any of a variety of available choices in such regards. Examples include but are not limited to email, short message service (SMS) text messages, the Gmail Notifier communications service, the Microsoft Lync communications service, the Cisco Jabber communications service, and so forth.

In a typical application setting the system may maintain a profile for such users that includes, for example, a preferred forwarding address (such as an email address or a mobile telephone number) and/or a preferred forwarding mechanism (such as emailing or texting). Such a profile can further provide for forwarding the aforementioned message using both of two or more different transmission modalities (such as both emailing and texting) (either simultaneously or within some very short period of time, such as within 1 second, 5 seconds, 15 seconds, 1 minute, 5 minutes, and so forth).

As yet another example in these regards the forwarding modality or details can be dynamically selected at the time of need based upon, for example, details regarding the caller (such as caller ID information or time of day) and/or details in the content of the message itself (such as the name of a specific person, project, or the like). So configured, and as a specific non-limiting illustrative example, a given user may prefer that text messages be sent to their mobile phone to receive messages being forwarded outside of work hours but may prefer email messages to receive messages being forwarded during work hours.

By one approach, the control circuit 101 may include with the text message some of the additional information described above and/or some of the analytical content described above. By automatically including such information with the message that includes the transcribed voice message, the called party has additional information available to consider the transcription in a fuller, richer context.

By one optional approach, if desired, the aforementioned message that contains the transcription can also include an appended file comprising the original voice message itself. The called party can then handle that audio file as they wish. For example, the called party can delete that audio file, play part or all of that audio file, forward that audio file, store that audio file, and so forth. Even in this case, however, it will be understood that the system itself does not maintain a voice-mail system that provides user-accessible voice-mail audio messages in ordinary course of use. Instead, the speech-to-text transcription constitutes the heart of this approach and inclusion of an audio file containing the original voice message is an accoutrement that supplements that text message without itself constituting a voice-mail system by another name.

As another option in these same regards, in lieu of the foregoing or in combination therewith, the recipient may be provided with an opportunity to stream the recorded voice message (by providing in the email or SMS message, for example, a link to the streaming source). The opportunity to stream the recorded message may be time limited and only be available, for example, for 30 minutes, 1 hour, 3 hours, or some other limited duration of time as desired.

These teachings are highly flexible in practice and will accommodate a wide variety of supplemental features and/or modifications. As one example in these regards, after converting the original voice message into a textual counterpart, the control circuit 101 could then arrange to translate that textual message into a different language (for example, by translating English text into French text) and then sending the translated text to the called party (with or without the original English text). Numerous other examples can be found in the attached Appendix, which Appendix comprises a part of this application and is otherwise fully incorporated herein by this reference.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

As one pertinent example in these regards, these teachings can be applied and leveraged in an application setting that lacks a PBX. Instead, for example, mobile users can simply conditionally forward their cellular phones to the aforementioned control circuit 101 and the latter will answer missed calls for such users in the same manner as is described above and absent any intervening PBX or PBX extension. Generally speaking, the above-described and configured control circuit 101 can accept a forwarded call from any session initiation protocol (SIP) trunk (for example, from a SIP number provisioned by a network carrier (such as Flowroute, Twilio, ATT, and so forth).

By way of a more specific example in these regards, by one approach an enterprise system administrator (or user) can add the user's mobile number to the control circuit 101 from, for example, the aforementioned user interface which might include a corresponding web portal to support this functionality. The user can then conditionally forward their phone to a pilot number provided by, for example, a system administrator by entering a corresponding set-up string. Conversely, this mobile forwarding can be deactivated when the user enters a deactivation string.

In such a case, the above-described system can answer multiple numbers for the same user. For example, if a user has an extension off an enterprise PBX and a mobile phone (or other number) the control circuit 101 can answer all of the user's calls. This approach creates a consistent caller experience and simplifies messaging for the individual because now all their messages to any of a variety of phones can be delivered to one inbox.

What is claimed is:

1. An apparatus comprising:
a control circuit operably coupled to a private branch exchange (PBX) and at least one network, the control circuit being configured to:
receive a forwarded call for a target recipient from the PBX;
receive via the forwarded call, and record, a speech message to provide a recorded speech message;
automatically converting at least a part of the recorded speech message into a corresponding transcribed text message;
automatically deleting at least a majority of the recorded speech message without first making the recorded speech message available to the target recipient via a voice-mail system.

2. The apparatus of claim 1 wherein the forwarded call comprises an unanswered forwarded call when received by the control circuit.

3. The apparatus of claim 1 wherein the control circuit automatically converts the at least a part of the recorded speech message into the corresponding transcribed text message by forwarding at least a part of the recorded speech message to an external speech transcription resource.

4. The apparatus of claim 1 wherein the control circuit is further configured to:
automatically forward at least a part of the transcribed text message to the target recipient.

5. The apparatus of claim 4 wherein the control circuit is further configured to:
automatically forward at least a part of the transcribed text message to a recipient other than the target recipient.

6. The apparatus of claim 1 wherein the control circuit is further configured to:
automatically check the transcribed text message for at least one predetermined expression of interest. The apparatus of claim 6 wherein the control circuit is further configured to:
upon determining that the transcribed text message includes the at least one predetermined expression of interest, automatically take at least one corresponding responsive action.

8. The apparatus of claim 7 wherein the corresponding responsive action comprises at least one of:
highlighting the at least one predetermined expression of interest in the transcribed text message when forwarding the transcribed text message to a recipient;
selecting a particular recipient to receive the transcribed text message;
archiving at least a portion of the transcribed text message.

9. The apparatus of claim 7 wherein the control circuit is further configured to:
provide a user with an opportunity to identify an expression as being the predetermined expression of interest.

10. The apparatus of claim 1 wherein the control circuit is further configured to:
access additional information and include the additional information when forwarding the transcribed text message to a recipient.

11. The apparatus of claim 10 wherein the control circuit is further configured to access the additional information as a function, at least in part, of at least one of:
content of the transcribed text message;
an identity of a party that originated the call.

12. The apparatus of claim 10 wherein the additional information comprises at least one of:
contact information regarding a party that originated the call;
personal information regarding the party that originated the call;
professional information regarding the party that originated the call.

13. The apparatus of claim 1 wherein the control circuit is further configured to:
automatically analyze the recorded speech message to provide analytical content.

14. The apparatus of claim 13 wherein the analytical content comprises at least one of:
a conclusion regarding a gender of a person who voiced the speech message;
a conclusion regarding an emotional state of the person who voiced the speech message;
a conclusion regarding a number of speakers who voiced the speech message;
a measure of a temporal duration of the speech message.

15. The apparatus of claim 13 wherein the analytical content comprises automatically selected trending expressions.

16. A method comprising:
by a control circuit operably coupled to a private branch exchange (PBX) and at least one network:
receiving a forwarded call for a target recipient from the PBX;
receiving via the forwarded call, and recording, a speech message to provide a recorded speech message;
automatically convert at least a part of the recorded speech message into a corresponding transcribed text message;
automatically delete at least a majority of the recorded speech message without first making the recorded speech message available to the target recipient via a voice-mail system.

17. The method of claim 16 further comprising:
automatically forwarding at least a part of the transcribed text message to a recipient.

18. The method of claim 17 further comprising:
automatically checking the transcribed text message for at least one predetermined expression of interest.

19. The method of claim 18 further comprising:
upon determining that the transcribed text message includes the at least one predetermined expression of interest, automatically taking at least one corresponding responsive action.

20. An apparatus configured to respond to unanswered calls by automatically transcribing a corresponding voice message from a corresponding calling party to text and forwarding at least part of that text to a corresponding called party without also maintaining an audio recording of the voice message in a voice-mail system.
